(19) United States
(12) Patent Application Publication
(10) Pub. No.: US 2016/0360713 A1
(43) Pub. Date: Dec. 15, 2016

(54) METHODS AND APPARATUS FOR ADJUSTING PLANT GROWTH ENVIRONMENT

(71) Applicant: Xiaomi Inc., Beijing (CN)

(72) Inventors: Ke WU, Beijing (CN); Xinyu Liu, Beijing (CN)

(73) Assignee: Xiaomi Inc.

(21) Appl. No.: 15/175,443

(22) Filed: Jun. 7, 2016

(30) Foreign Application Priority Data
Jun. 10, 2015 (CN) 201510317290.7

(51) Int. Cl. A01G 9/26; A01G 1/00; A01G 7/04; A01G 7/02; G06F 17/30; A01G 9/24

(52) U.S. Cl. CPC A01G 9/26; G06F 17/30477; A01G 9/241; A01G 7/04; A01G 7/02; A01G 9/246; A01G 1/001

(57) ABSTRACT

Disclosed includes a method for remote management of one or more cultivation conditions for a plant is provided. The method is performed by a computer processor and comprises: acquiring, from a database, a set of cultivation curves of a plant in a pot; acquiring, from one or more sensors associated with the pot, a set of environment parameters associated with a location of the pot; adjusting the set of cultivation curves of the plant based on the set of environment parameters; adjusting a set of cultivation conditions for the plant based on the set of adjusted cultivation curves; determining one or more settings for one or more electronic appliances based on the cultivation conditions; and transmitting one or more instructions related to the one or more settings to the one or more electronic appliances.

This application is based upon and claims priority to Chinese Patent Application No. 201510317290.7, filed on Jun. 10, 2015, which is incorporated herein by reference in its entirety.

### TECHNICAL FIELD

The present disclosure relates to the field of computer network technologies and, more particularly, to a method and an apparatus for management of one or more cultivation conditions for a plant remotely over a computer network.

### BACKGROUND

It is common to grow plants indoors, which can improve the indoor air quality and environment. These plants are typically grown in pots, and a plant is typically subjected to a set of cultivation conditions associated with a location and an environment in which the plant is grown. For example, a plant located in a balcony is generally exposed to sunlight for a relatively long duration, while a plant located in a bedroom is generally exposed to sunlight for a relatively short duration. In a case where plants are grown at different indoor environments, each plant may need to be provided with a different set of cultivation conditions adapted to the different indoor environments, to improve the likelihood that these indoor plants will survive, and to improve the indoor air quality and environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a method for remote management of one or more cultivation conditions for a plant is provided. The method is performed by a computer processor and comprises: acquiring, from a database, a set of cultivation curves of a plant in a pot; acquiring, from one or more sensors associated with the pot, a set of environment parameters associated with a location of the pot; adjusting the set of cultivation curves of the plant based on the set of environment parameters; adjusting a set of cultivation conditions for the plant based on the set of adjusted cultivation curves; determining one or more settings for one or more electronic appliances based on the cultivation conditions; and transmitting one or more instructions related to the one or more settings to the one or more electronic appliances.

In another aspect, an apparatus for remote management of one or more cultivation conditions for a plant is provided. The apparatus comprises: a processor and a memory for storing instructions executable by the processor. The processor is configured to: acquire, from a database, a set of cultivation curves of a plant in a pot; acquire, from one or more sensors associated with the pot, a set of environment parameters associated with a location of the pot; adjust the set of cultivation curves of the plant based on the set of environment parameters; adjust a set of cultivation conditions for the plant based on the set of adjusted cultivation curves; determine one or more settings for one or more electronic appliances based on the cultivation conditions; and transmit one or more instructions related to the one or more settings to the one or more electronic appliances.

In another aspect, a non-transitory computer-readable storage medium is provided. The non-transitory computer-readable storage medium stores instructions that, when executed by one or more processors of an apparatus, cause the apparatus to perform a method for remote management of one or more cultivation conditions for a plant. The method comprises: acquiring, from a database, a set of cultivation curves of a plant in a pot; acquiring, from one or more sensors associated with the pot, a set of environment parameters associated with a location of the pot; adjusting a set of cultivation curves of the plant based on the set of environment parameters; adjusting a set of cultivation conditions for the plant based on the set of adjusted cultivation curves; determining one or more settings for one or more electronic appliances based on the cultivation conditions; and transmitting one or more instructions related to the one or more settings to the one or more electronic appliances.

It should be understood that both the foregoing general description and the following detailed description are only exemplary and are not restrictive of the invention.

### BRIEF DESCRIPTION OF THE DRAWINGS

The accompanying drawings herein, which are incorporated into and constitute a part of the specification, illustrate embodiments consistent with the present disclosure, and together with the specification, serve to explain the principles of the present disclosure.

FIG. 1A is a flowchart illustrating a method for management of a set of plant cultivation conditions, according to an exemplary embodiment of the present disclosure.

FIG. 1B is a schematic diagram illustrating an apparatus for management of a set of plant cultivation conditions, according to an exemplary embodiment of the present disclosure.

FIG. 1C is a schematic diagram illustrating another apparatus for management of a set of plant cultivation conditions, according to an exemplary embodiment of the present disclosure.

FIG. 2 is a flowchart illustrating another method for management of a set of plant cultivation conditions, according to an exemplary embodiment of the present disclosure.

FIG. 3 is a flowchart illustrating another method for management of a set of plant cultivation conditions, according to an exemplary embodiment of the present disclosure.

FIG. 4 illustrates a block diagram of a system for management of a set of plant cultivation conditions, according to an exemplary embodiment of the present disclosure.

FIG. 5 illustrates components of the system as shown in FIG. 4.

FIG. 6 is a system architecture diagram illustrating an apparatus in which embodiments of the present disclosure can be implemented.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

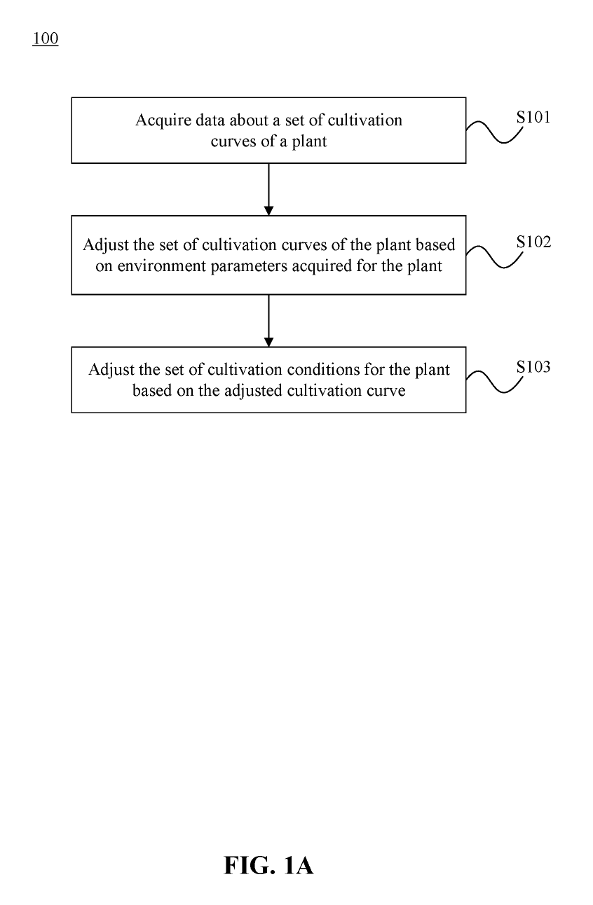

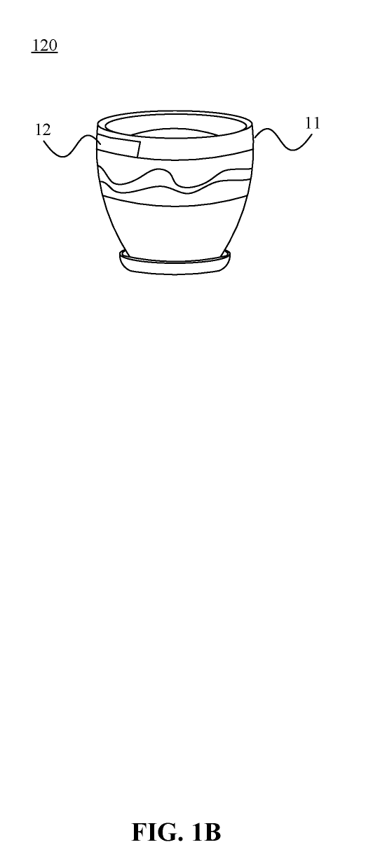

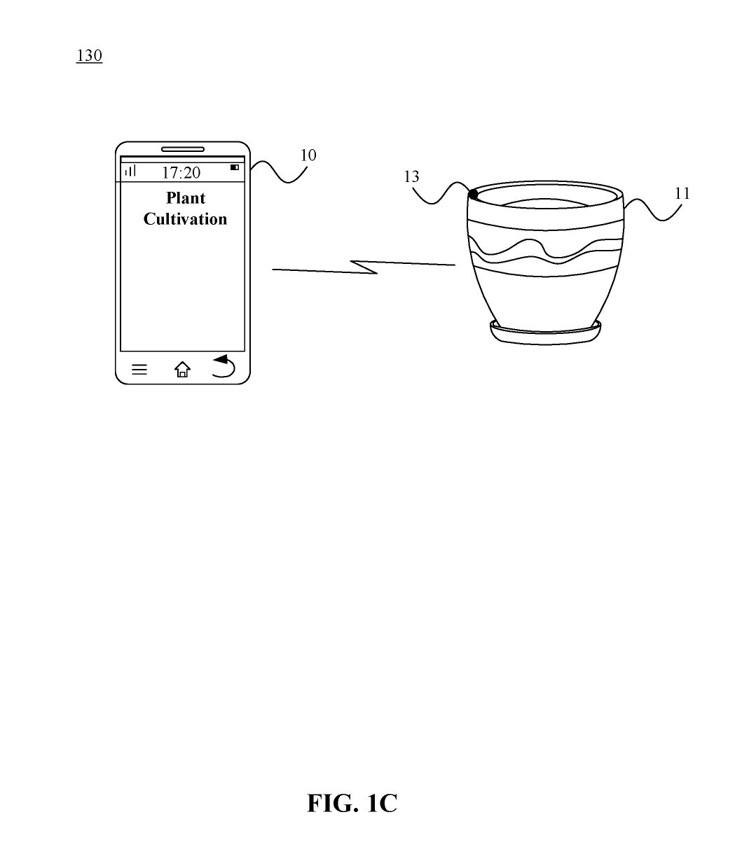

FIG. 1A is a flowchart illustrating a method 100 for management of a set of plant cultivation conditions, according to an example embodiment of the present disclosure. Method 100 can be performed by a system that includes (or is coupled with) a database, and one or more sensors configured to acquire environment parameters associated with a location of a plant. The system can include one or more computer processors configured to execute instructions and can include, for example, a terminal device, a smart phone, a tablet computer, a smart pot, etc. As shown in FIG. 1A, the method 100 includes steps S101 to S103.

In step S101, the system acquires data about a set of cultivation curves of a plant.

In one embodiment, the cultivation curves can provide information about threshold cultivation conditions to achieve a predetermined growth trend of the plant with respect to time. The cultivation conditions can include, for example, an intensity of sunlight the plant is exposed to, a temperature, and a humidity of an environment in which the plant is located, etc. The set of cultivation curves can be associated with different growth stages of the plant (e.g., a period of exponential growth, a period of linear growth, a decay period, etc.). The threshold cultivation conditions can also be categorized based on a type of the plant. Based on information about a type of the plant, as well as a growth stage of the plant, the system can retrieve a set of threshold cultivation conditions for the plant. As to be discussed below, a set of cultivation conditions for the plant can be adjusted based on the threshold conditions. The plant can be grown in a pot indoors.

In step S102, the system adjusts the set of cultivation curves of the plant based on environment parameters acquired for the plant.

In one embodiment, the environment parameters may be associated a spatial location of the plant. The one or more sensors of the system can be mounted on a pot in which the plant is grown, and can be configured to acquire environment parameters such as: a duration of exposure to sunlight, temperature, humidity, etc. The cultivation curve of the plant can be adjusted based on these environment parameters. As a result, plants of the same type but at different locations, as well as plants of different types and at the same location, can be associated with different cultivation curves.

In step S103, the system adjusts the set of cultivation conditions for the plant based on the adjusted cultivation curve.

In one embodiment, the system can determine a relationship between the environment parameters acquired for the plant, and the threshold cultivation conditions associated with the adjusted cultivation curve of the plant, and determine an action to manage a set of cultivation conditions for the plant based on the relationship. For example, if the system determines that a duration of sunlight exposure exceeds a maximum threshold (or falls below a minimum threshold) associated with the adjusted cultivation curve of the plant, the system may cause the duration of sunlight exposure to be adjusted. For example, the system may cause an adjustment of a sunshade on a window, transmitting a signal to a motor to rotate a pot so that the plant faces a different direction, etc. Also, if the system determines that the humidity and/or the temperature exceed a maximum threshold (or fall below a minimum threshold) associated with the adjusted cultivation curve of the plant, the system may cause the humidity to be adjusted by, for example, adjusting a setting of an air conditioner, transmitting a signal to a motor that controls a window frame to open or close a window, etc. In some embodiments, the system may also provide an indication to a user to adjust the set of cultivation conditions.

The management of the cultivation conditions can occur over a computer network. For example, the system can acquire data about the cultivation curves from a database via a cloud-based server. The system can also acquire the environment parameters of the plants at different locations over the computer network, and remotely control the operation of various appliances (e.g., air conditioner, fans, a pot with a motor for self-rotation, etc.) over the computer network to adjust the sunlight exposure duration, the temperature, and the humidity. The system may also transmit the environment parameters, over the computer network, to a user terminal for displaying.

Reference is now made to FIG. 1B, which illustrates an apparatus 120 for management of a set of plant cultivation conditions, according to an exemplary embodiment of the present disclosure. As shown in FIG. 1B, the apparatus 120 includes a pot 11 and a terminal device 12. The terminal device 12 acquires the environment parameters associated with a location of the pot 11. In one embodiment, the environment parameters acquired by the terminal device 12 may include: a duration of sunlight exposure within a predetermined time period, a maximum temperature and a minimum temperature within the predetermined time period, a maximum humidity and a minimum humidity within the predetermined time period, etc. In addition, the terminal device 12 may further include a display module (not shown in the drawings) configured to display the acquired environment parameters for a user. In one embodiment, the terminal device 12 may further include a communication interface (not shown in the drawings) configured to receive data related to a growth trend of the plant from the database via, for example, a cloud-based server.

FIG. 1C illustrates an apparatus 130 for management of a set of plant cultivation conditions, according to an exemplary embodiment of the present disclosure. As shown in FIG. 1C, the apparatus 130 includes the pot 11 of FIG. 1B, and a sensor apparatus 13. The sensor apparatus 13 is communicatively coupled with a smart device 10. In one embodiment, the sensor apparatus 13 may include at least one of a light irradiation sensor, a temperature sensor, and a humidity sensor. The light irradiation sensor is configured to detect an intensity of sunlight the pot 11 is exposed to within a predetermined time period. The temperature sensor is configured to detect a temperature of the pot. The humidity sensor is configured to detect a humidity of the pot. The data can be transmitted wirelessly to a system (e.g., smart device 10). The system can then, based on the data acquired by the light irradiation sensor, the temperature sensor, and the humidity sensor, determine environment parameters including: a duration of sunlight exposure within a predetermined time period, a maximum temperature and a minimum temperature within the predetermined time period, a maximum humidity and a minimum humidity within the predetermined time period, etc. The predetermined time period can be, for example, a day, a year, etc.

As an illustrative example, based on the duration of sunlight exposure, the system can determine an amount of sunlight received by the plant. Also, based on the maximum temperature and the minimum temperature, the system can determine a temperature variation at a particular location. For example, the system can determine that a pot located on the roof of a building is subjected to a greater temperature difference than a pot located indoors. Also, the system can determine that a pot situated in a room with air conditioning is subjected to a smaller temperature difference than a pot situated in a room without air conditioning. Further, the system can also determine a humidity variation at a particular location, based on the maximum humidity and the minimum humidity.

In one embodiment, the smart device 10 may acquire data about a cultivation curve corresponding to the plant from the database via a cloud-based server. In some embodiments, the cultivation curve data is associated with a type of plant information, and the smart device 10 may extract the cultivation curve data using the type of plant information.

In one embodiment, a cultivation curve for a plant is adjusted according to one or more environment parameters associated with a location of the pot, such that plants of the same type but at different locations, as well as plants of different types and at the same location, can be associated with different cultivation curves.

With embodiments of the present disclosure, a system can manage a set of cultivation conditions for a plant based on a cultivation curve which is adjusted according to one or more environment parameters associated with a location of the plant. As a result, the survivability and the growth of the plant can be facilitated, and the indoor air quality and the indoor environment can also be improved as well.

In one embodiment, the set of cultivation curves includes a sunlight exposure duration curve, which can be adjusted based on environment parameters including a duration of sunlight exposure of the plant measured within a predetermined time. The duration of sunlight exposure can be determined based on data about an intensity of sunlight acquired by a light irradiation sensor mounted on the pot in which the plant is grown. The cultivation curves may also include a temperature variation curve, which can be adjusted based on environment parameters including a temperature range of the environment in which the plant is located within the predetermined time. The temperature range can be determined based on data about a maximum temperature and a minimum temperature acquired by a temperature sensor mounted on the pot. The cultivation curves may also include a humidity variation curve, which can be adjusted based on environment parameters including a humidity range of the environment where the plant is located within the predetermined time. The humidity range can be determined based on data about a maximum humidity and a minimum humidity acquired by a humidity sensor mounted on the pot.

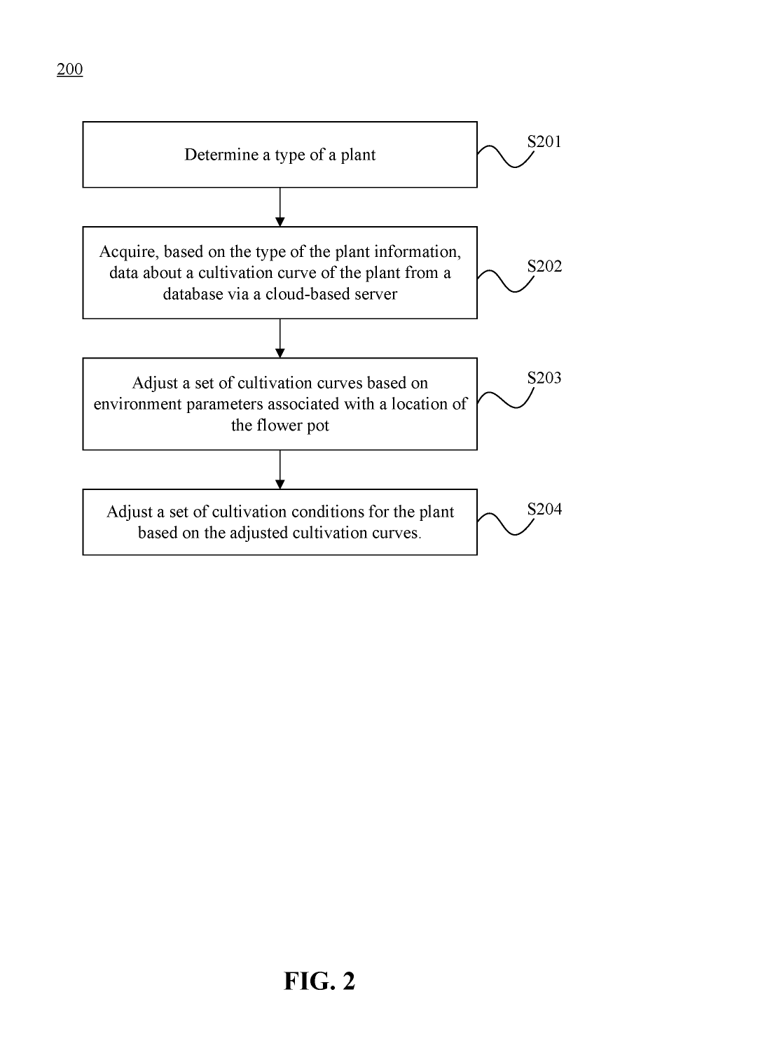

FIG. 2 is a flowchart illustrating a method 200 for management of a set of plant cultivation conditions, according to an exemplary embodiment of the present disclosure. The method 200 can be performed by a system that includes (or is coupled with) a database, and one or more sensors configured to acquire environment parameters associated with a location of a plant. The system can be a terminal device such as, for example, a smart phone, a tablet computer, a smart pot, etc. As shown in FIG. 2, the method 200 includes steps S201 to S204.

In step S201, the system determines a type of a plant. The plant can be grown in a pot indoors. The type information can be determined based on, for example, information about the pot. As an illustrative example, the database can store a mapping between an identifier of a pot and type information of the plant cultivated in the pot. Based on the identifier of the pot, the system can then determine the type of the plant cultivated in the pot.

In step S202, the system, based on the type of the plant information, acquires data about a cultivation curve of the plant from a database via a cloud-based server.

In one embodiment, as shown in FIG. 1B, the type of plant information can be determined using the terminal device 12 disposed on the pot 11 in which the plant is grown. Terminal device 12 can then transmit the type of plant information to a cloud-based server via the communication interface on the terminal device 12, and then receive data of a cultivation curve from the cloud-based server. In another embodiment, as shown in FIG. 1C, the smart device 10 may also transmit the type of plant information to the cloud-based server, and acquire the data of cultivation curve from the cloud-based server.

As an illustrative example, an epipremnum aureum is grown in the pot 11. The terminal device 12 (or smart device 10) may transmit data indicating a type of epipremnum aureum to the cloud-based server to enable the cloud-based server to search for a growth curve corresponding to epipremnum aureum, which can then transmit data about the cultivation curve back to the terminal device 12 (or smart device 10).

In step S203, the system adjusts a set of cultivation curves based on environment parameters associated with a location of the pot.

In step S204, the system adjusts a set of cultivation conditions for the plant based on the adjusted cultivation curves.

Description of steps S203 and S204 may be referenced to the above description of steps S102 and S103, respectively, the details of which are not repeated here.

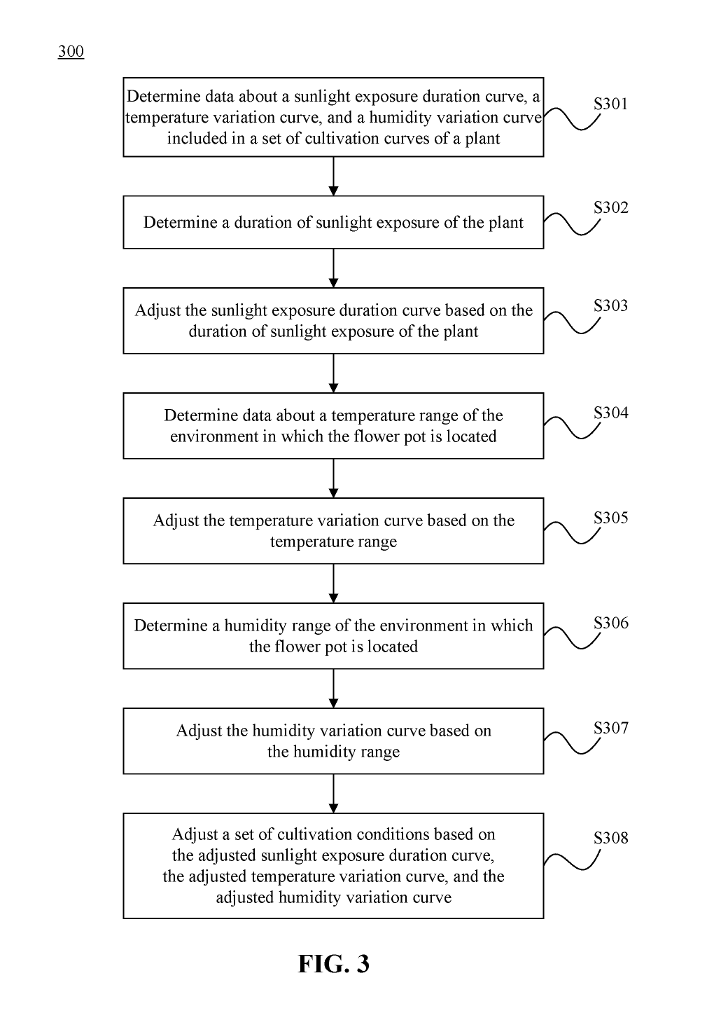

FIG. 3 is a flowchart illustrating a method 300 for management of a set of plant cultivation conditions, according to an exemplary embodiment of the present disclosure. The method 300 can be performed by a system that includes (or is coupled with) a database, and one or more sensors configured to acquire environment parameters associated with a location of a plant. The system can be a terminal device such as, for example, a smart phone, a tablet computer, a smart pot, etc. As shown in FIG. 3, the method 300 includes steps S301 to S308.

In step S301, the system determines data about a sunlight exposure duration curve, a temperature variation curve, and a humidity variation curve included in a set of cultivation curves of a plant. The plant can be grown in a pot indoors. The data can be acquired from a database by, for example, the terminal device 12 of FIG. 1B, the smart device 10 of FIG. 1C, etc.

In step S302, the system determines a duration of sunlight exposure of the plant within a predetermined time (e.g., a day, a year, etc.). The duration of sunlight exposure can be determined based on data about an intensity of sunlight acquired by a light irradiation sensor (e.g., the sensor apparatus 13) mounted on the pot in which the plant is grown.

In step S303, the system adjusts the sunlight exposure duration curve based on the duration of sunlight exposure of the plant determined in step S302.

In step S304, the system determines data about a temperature range of the environment in which the pot is located. The temperature range can be determined based on data about a maximum temperature and a minimum temperature acquired by a temperature sensor (e.g., the sensor apparatus 13) mounted on the pot.

In step S305, the system adjusts the temperature variation curve based on the temperature range determined in step S304.

In step S306, the system determines a humidity range of the environment in which the pot is located. The humidity range can be determined based on data about a maximum humidity and a minimum humidity acquired by a humidity sensor mounted on the pot.

In step S307, the system adjusts the humidity variation curve based on the humidity range determined in step S306.

In step S308, the system adjusts a set of cultivation conditions based on the adjusted sunlight exposure duration curve, the adjusted temperature variation curve, and the adjusted humidity variation curve.

For example, if the system determines that a duration of sunlight exposure exceeds a maximum threshold (or falls below a minimum threshold) associated with the adjusted sunlight exposure duration curve of the plant, the system may cause the duration of sunlight exposure to be adjusted. For example, the system may cause an adjustment of a sunshade for the plant, cause the pot to be turned so that the plant faces a different direction, etc. Moreover, if the system determines that a temperature of the environment in which the pot is located exceeds a maximum threshold (or falls below a minimum threshold) associated with the adjusted temperature variation curve, the system may cause the temperature to be adjusted by, for example, adjusting a setting of an air conditioner, etc. Further, if the system determines that a humidity of the environment in which the pot is located exceeds a maximum threshold (or falls below a minimum threshold) associated with the adjusted humidity variation curve, the system may cause the temperature to be adjusted by, for example, adjusting a setting of an air conditioner, transmitting a signal to a motor that controls a window frame to open or close a window, etc. In some embodiments, the system can also provide an indication to a user to adjust the set of cultivation conditions.

With embodiments of the present disclosure, a system can manage a set of cultivation conditions for a plant based on a set of cultivation curves, including a sunlight exposure duration curve, a temperature variation curve, and a humidity variation curve. These curves can be adjusted based on one or more environment parameters associated with a location of the plant including a duration of sunlight exposure of the plant, a temperature range and a humidity range of the environment in which the plant is located, etc. As a result, the survivability and the growth of the plant can be facilitated, and the indoor air quality and environment can also be improved as well.

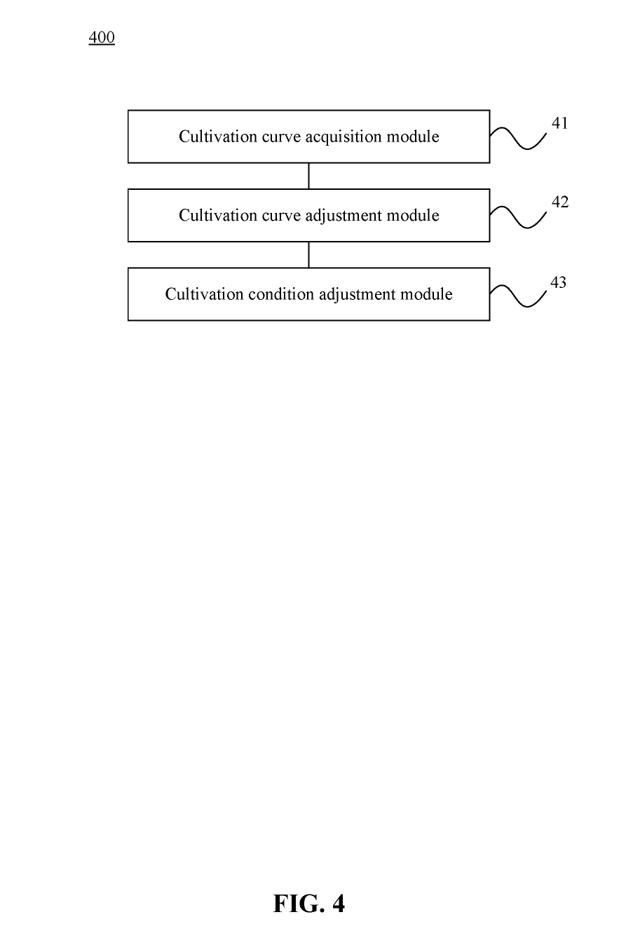

FIG. 4 is a block diagram illustrating a system 400 for management of a set of plant cultivation conditions, according to an exemplary embodiment of the present disclosure. System 400 can include one or more computer processors configured to execute instructions to perform, for example, method 100 of FIG. 1A, method 200 of FIG. 2, and method 300 of FIG. 3. System 400 can include, for example, a terminal device (e.g., the terminal device 12 of FIG. 1B), a smart phone (e.g., the smart device 10 of FIG. 1C), a tablet computer, a smart pot, etc. As shown in FIG. 4, system 400 includes a cultivation curve acquisition module 41, a cultivation curve adjustment module 42, and a cultivation condition adjustment module 43.

The cultivation curve acquisition module 41 is configured to acquire data about a set of cultivation curves of a plant. The data can be acquired from a database via a cloud-server. In some embodiments, cultivation curve acquisition module 41 is configured to perform, for example, step S101 of FIG. 1A.

The cultivation curve adjustment module 42 is configured to adjust the set of cultivation curves acquired by the cultivation curve acquisition module 41 based on the environment parameters associated with a location of the plant. In some embodiments, cultivation curve adjustment module 42 is configured to perform, for example, step S102 of FIG. 1A.

The cultivation condition adjustment module 43 is configured to adjust the cultivation condition of the plant based on the set of adjusted cultivation curves from cultivation curve adjustment module 42. In some embodiments, cultivation condition adjustment module 43 is configured to perform, for example, step S103 of FIG. 1A, step S204 of FIG. 2, and step S308 of FIG. 3.

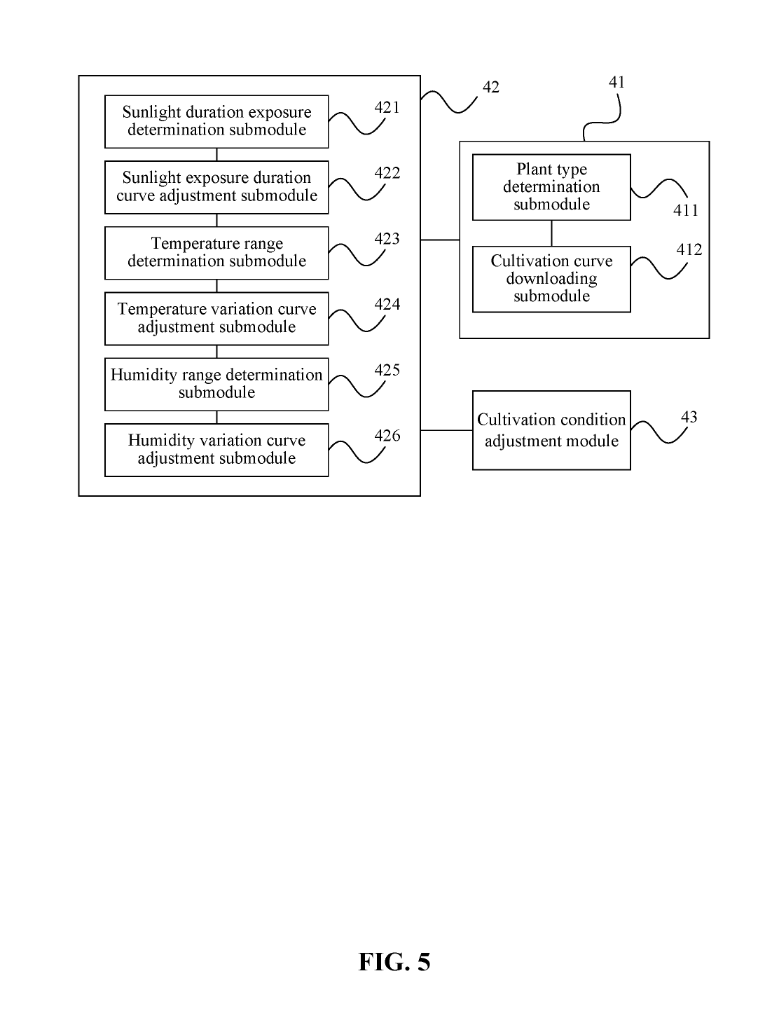

FIG. 5 illustrates an exemplary configuration of the system 400, according to an embodiment. As shown in FIG. 5, the cultivation curve acquisition module 41 includes a plant type determination submodule 411 and a cultivation curve downloading submodule 412. Cultivation curve adjustment module 42 includes a sunlight duration exposure determination submodule 421, a sunlight exposure duration curve adjustment submodule 422, a temperature range determination submodule 423, a temperature variation curve adjustment submodule 424, a humidity range determination submodule 425, and a humidity variation curve adjustment submodule 426.

The plant type determination submodule 411 can determine the type of the plant. The type information can be determined based on, for example, information about the pot. As an illustrative example, a database can store a mapping between an identifier of a pot and type information of the plant cultivated in the pot. Based on the identifier of the pot, the system can then determine the type of the plant cultivated in the pot. In some embodiments, the plant type determination submodule 411 is configured to perform, for example, step S201 of FIG. 2.

The cultivation curve downloading submodule 412 is configured to download data for a set of cultivation curves corresponding to the plant type from the database via a cloud-based server, using the plant type information determined by the plant type determination submodule 411. The set of cultivation curves includes: a sunlight exposure duration curve, a temperature variation curve, and a humidity variation curve. In some embodiments, the cultivation curve downloading submodule 412 is configured to perform, for example, step S202 of FIG. 2 and step S301 of FIG. 3.

The sunlight duration exposure determination submodule 421 is configured to determine a duration of sunlight exposure of the plant within a predetermined time (e.g., a day, a year, etc.). The duration of sunlight exposure can be determined based on data about an intensity of sunlight acquired by a light irradiation sensor (e.g., the sensor apparatus 13) mounted on the pot in which the plant is grown. In some embodiments, the sunlight duration exposure determination submodule 421 is configured to perform, for example, step S202 of FIG. 2 and step S302 of FIG. 3.

The sunlight exposure duration curve adjustment submodule 422 is configured to adjust the sunlight exposure duration curve based on the duration of sunlight exposure determined by the sunlight duration exposure determination submodule 421. In some embodiments, the sunlight exposure duration curve adjustment submodule 422 is configured to perform, for example, step S203 of FIG. 2 and step S303 of FIG. 3.

The temperature range determination submodule 423 is configured to determine a temperature range of the plant at the location of the pot. The temperature range can be determined based on data about a maximum temperature and a minimum temperature acquired by a temperature sensor (e.g., the sensor apparatus 13) mounted on the pot. In some embodiments, the sunlight exposure duration curve adjustment submodule 422 is configured to perform, for example, step S202 of FIG. 2 and step S304 of FIG. 3.

The temperature variation curve adjustment submodule 424 is configured to adjust the temperature variation curve based on the temperature range determined by the temperature range determination submodule 423. In some embodiments, the temperature variation curve adjustment submodule 424 is configured to perform, for example, step S203 of FIG. 2 and step S305 of FIG. 3.

The humidity range determination submodule 425 is configured to determine a humidity range of the environment in which the pot is located. The humidity range can be determined based on data about a maximum humidity and a minimum humidity acquired by a humidity sensor mounted on the pot. In some embodiments, the humidity range determination submodule 425 is configured to perform, for example, step S202 of FIG. 2 and step S306 of FIG. 3.

The humidity variation curve adjustment submodule 426 is configured to adjust the humidity variation curve based on the humidity range determined by the humidity range determination submodule 425. In some embodiments, the humidity variation curve adjustment submodule 426 is configured to perform, for example, step S203 of FIG. 2 and step S307 of FIG. 3.

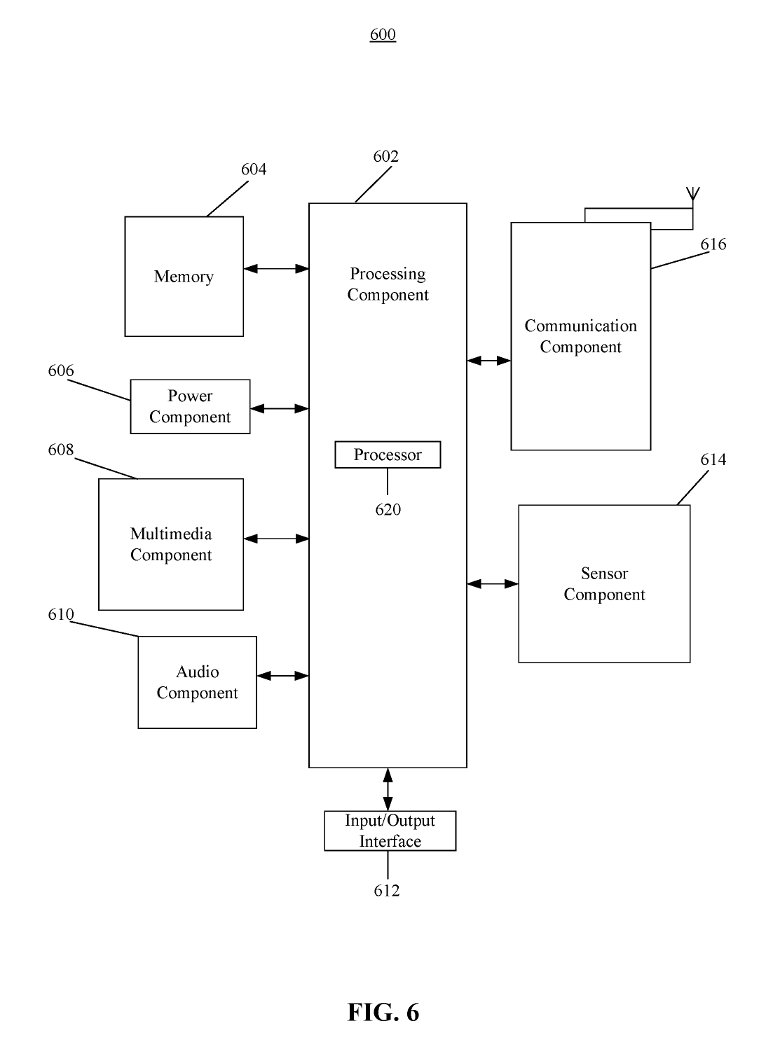

FIG. 6 is a block diagram illustrating an apparatus for use in adjusting a plant growth environment according to an example embodiment of the present disclosure. For example, the apparatus 600 may be a mobile phone, a computer, a digital broadcast terminal, a messaging device, a gaming console, a tablet, a medical device, exercise equipment, a personal digital assistant, and the like.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 620 to execute instructions to perform all or a part of the steps in the above-described methods. In addition, the processing component 602 may include one or more modules which facilitate the interaction between the processing component 602 and other components. For example, the processing component 602 may include a multimedia module to facilitate the interaction between the multimedia component 608 and the processing component 602.

The memory 604 is configured to store various types of data to support the operations of the apparatus 600. Examples of such data include instructions for any application or method operated on the apparatus 600, contact data, phonebook data, messages, pictures, videos, and the like. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 604 can include a non-transitory computer readable medium to store instructions that correspond to any of the modules and sub-modules of FIG. 4 and FIG. 5. The instructions, when executed by the one or more processors 620 of the processing component 602, can also cause the one or more processors 620 to perform, for example, the method 100 of FIG. 1A, the method 200 of FIG. 2, and the method 300 of FIG. 3.

The power component 606 provides power to various components of the apparatus 600. The power component 606 may include a power management system, one or more power supplies, and other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and/or the rear camera may receive external multimedia data while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive an external audio signal when the apparatus 600 is in an operation mode, such as a call mode, a recording mode, or a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and a peripheral interface module, such as a keyboard, a click wheel, a button, or the like. The buttons may include, but are not limited to, a home button, a volume button, a starting button, and a locking button.

The sensor component 614 includes one or more sensors to provide status assessments of various aspects of the apparatus 600. For example, the sensor component 614 may detect an open/closed status of the apparatus 600, relative positioning of components, e.g., the display and the keypad, of the apparatus 600, a change in position of the sensor component 614 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communications, wired or wirelessly, between the apparatus 600 and other devices. The apparatus 600 may access a wireless network based on a communication standard, such as WiFi, 2G, or 3G, or a combination thereof. In one example embodiment, the communication component 616 receives a broadcast signal or broadcast associated information from an external broadcast management system via a broadcast channel In one example embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In example embodiments, there is also provided a non-transitory computer-readable storage medium including instructions, such as included in the memory 604, executable by the processor 620 in the apparatus 600, for performing the above-described methods. For example, the non-transitory computer-readable storage medium may be a ROM, a random access memory (RAM), a compact disc read-only memory (CD-ROM), a magnetic tape, a floppy disc, an optical data storage device, or the like.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

1. A method for remote management of one or more cultivation conditions for a plant, the method being performed by a computer processor, comprising:
acquiring, from a database, a set of cultivation curves of a plant in a pot;
acquiring, from one or more sensors associated with the pot, a set of environment parameters associated with a location of the pot;
adjusting the set of cultivation curves of the plant based on the set of environment parameters;
adjusting a set of cultivation conditions for the plant based on the set of adjusted cultivation curves;
determining one or more settings for one or more electronic appliances based on the cultivation conditions; and
transmitting one or more instructions related to the one or more settings to the one or more electronic appliances.

2. The method according to claim 1, wherein the acquiring a set of cultivation curves of a plant in a pot includes:
determining a type of the plant; and
acquiring, from the database, a set of cultivation curves that correspond to the type of the plant.

3. The method according to claim 1, wherein the set of cultivation curves includes a sunlight exposure duration curve; wherein the set of environment parameters includes a duration of sunlight exposure of the plant within a predetermined time; and wherein the adjusting the set of cultivation curves includes adjusting the sunlight exposure duration curve based on the duration of sunlight exposure.

4. The method according to claim 1, wherein the set of cultivation curves includes a temperature variation curve; wherein the set of environment parameters includes a temperature range of an environment in which the pot is located; and wherein the adjusting the set of cultivation curves includes adjusting the temperature variation curve based on the temperature range.

5. The method according to claim 1, wherein the set of cultivation curves includes a humidity variation curve; wherein the set of environment parameters includes a humidity range of an environment in which the pot is located; and wherein the adjusting the set of cultivation curves includes adjusting the humidity variation curve is based on the humidity range.

6. The method according to claim 1, wherein the transmitting one or more instructions related to the one or more settings to the one or more electronic appliances comprises at least one of:
transmitting one or more instructions related to one or more settings of an air conditioner,
transmitting a signal to a motor that controls a window frame to open or close a window, and
transmitting a signal to a motor to rotate the pot.

7. An apparatus for remote management of one or more cultivation conditions for a plant, comprising:
a processor; and
a memory for storing instructions executable by the processor;
wherein the processor is configured to:
acquire, from a database, a set of cultivation curves of a plant in a pot;
acquire, from one or more sensors associated with the pot, a set of environment parameters associated with a location of the pot;
adjust the set of cultivation curves of the plant based on the set of environment parameters;
adjust a set of cultivation conditions for the plant based on the set of adjusted cultivation curves;
determine one or more settings for one or more electronic appliances based on the cultivation conditions; and
transmit one or more instructions related to the one or more settings to the one or more electronic appliances.

8. The apparatus according to claim 7, wherein the processor is further configured to:
determine a type of the plant; and
acquire, from the database, a set of cultivation curves that correspond to the type of the plant.

9. The apparatus according to claim 7, wherein the set of cultivation curves includes a sunlight exposure duration curve; wherein the set of environment parameters includes a duration of sunlight exposure of the plant within a predetermined time; and wherein the adjusting the set of cultivation curves includes adjusting the sunlight exposure duration curve based on the duration of sunlight exposure.

10. The apparatus according to claim 7, wherein the set of cultivation curves includes a temperature variation curve; wherein the set of environment parameters includes a temperature range of an environment in which the pot is located; and wherein the adjusting the set of cultivation curves includes adjusting the temperature variation curve based on the temperature range.

11. The apparatus according to claim 7, wherein the set of cultivation curves includes a humidity variation curve; wherein the set of environment parameters includes a humidity range of an environment in which the pot is located; and wherein the adjusting the set of cultivation curves includes adjusting the humidity variation curve is based on the humidity range.

12. The apparatus according to claim 7, wherein the processor is configured to perform at least one of:
transmitting one or more instructions related to one or more settings of an air conditioner,
transmitting a signal to a motor that controls a window frame to open or close a window, and
transmitting a signal to a motor to rotate the pot.

13. A non-transitory computer-readable storage medium having stored therein instructions that, when executed by one or more processors of an apparatus, cause the apparatus to perform a method for remote management of one or more cultivation conditions for a plant, the method comprising:
acquiring, from a database, a set of cultivation curves of a plant in a pot;
acquiring, from one or more sensors associated with the pot, a set of environment parameters associated with a location of the pot;
adjusting a set of cultivation curves of the plant based on the set of environment parameters;
adjusting a set of cultivation conditions for the plant based on the set of adjusted cultivation curves;
determining one or more settings for one or more electronic appliances based on the cultivation conditions; and
transmitting one or more instructions related to the one or more settings to the one or more electronic appliances.

14. The non-transitory computer-readable storage medium of claim 13, wherein the acquiring a set of cultivation curves of a plant in a pot includes:
determining a type of the plant; and
acquiring, from the database, a set of cultivation curves that correspond to the type of the plant.

15. The non-transitory computer-readable storage medium of claim 13, wherein the set of cultivation curves includes a sunlight exposure duration curve; wherein the set of environment parameters includes a duration of sunlight exposure of the plant within a predetermined time; and wherein the adjusting the set of cultivation curves includes adjusting the sunlight exposure duration curve based on the duration of sunlight exposure.

16. The non-transitory computer-readable storage medium of claim 13, wherein the set of cultivation curves includes a temperature variation curve; wherein the set of environment parameters includes a temperature range of an environment in which the pot is located; and wherein the adjusting the set of cultivation curves includes adjusting the temperature variation curve based on the temperature range.

17. The non-transitory computer-readable storage medium of claim 13, wherein the set of cultivation curves includes a humidity variation curve; wherein the set of environment parameters includes a humidity range of an environment in which the pot is located;
and wherein the adjusting the set of cultivation curves includes adjusting the humidity variation curve is based on the humidity range.

18. The non-transitory computer-readable storage medium of claim 13, wherein the transmitting one or more instructions related to the one or more settings to the one or more electronic appliances comprises at least one of:
transmitting one or more instructions related to one or more settings of an air conditioner,
transmitting a signal to a motor that controls a window frame to open or close a window, and
transmitting a signal to a motor to rotate the pot.
